(19) United States
(12) Patent Application Publication
(10) Pub. No.: US 2025/0145806 A1
(43) Pub. Date: May 8, 2025

(54) AMMONIA-FREE LATEX COMPOSITIONS

(71) Applicant: AFLATEX Technologies, LDA, Lisboa (PT)

(72) Inventors: Julio Cesar Rodríguez, Victoria (CO); Tim A. Osswald, Madison, WI (US)

(21) Appl. No.: 18/833,476

(22) PCT Filed: Jan. 24, 2023
(86) PCT No.: PCT/IB2023/000064

§ 371 Date: Jul. 26, 2024

Related U.S. Application Data
(60) Provisional application No. 63/267,167, filed on Jan. 26, 2022.

(51) Int. Cl. C08L 7/02; C08C 1/06; C08C 1/15; C08K 5/06; C08K 5/42

(52) U.S. Cl. CPC C08L 7/02; C08C 1/06; C08C 1/15; C08K 5/06; C08K 5/42

(57) ABSTRACT

Provided herein are methods for processing natural rubber, also referred to as latex, without the use of ammonia. The methods provided herein may comprise one or more of the following steps: (a) a collection step wherein liquid latex is collected from a plant and, preferably, is filtered to remove impurities from the environment; (b) a stabilization step wherein a liquid latex composition is refrigerated and/or contacted with a stabilizing agent; (c) a preservation step wherein the liquid latex composition is contacted with a preserving agent; (d) a pH adjustment step wherein the liquid latex composition is contacted with a pH adjusting agent; (e) a storage step wherein the liquid latex composition is stored for a period of time; and (f) a coagulation step wherein the liquid latex composition is contacted with a coagulation agent, thereby forming a solid latex composition. Also provided herein are stabilized and preserved liquid latex compositions having a long shelf life, and solid rubber compositions having advantageous physical and chemical properties.

### BACKGROUND

Ammonia is a key ingredient in conventional methods for processing natural rubber latex.

When processing the latex that is extracted from the tree, small amounts of ammonia are typically added to inhibit coagulation as the latex is transported to the processing facility. In addition to ammonia, a biocide is conventionally used to preserve the latex to inhibit bacterial action and decomposition. Conventionally, high amounts of ammonia (˜4% by weight) and low amounts of biocide (˜1%), or low amounts of ammonia (˜1%) and high amounts of biocide (˜4%) are required.

Once the latex is processed, the waste product residue, which is approximately 65% of the extracted material, is typically discarded. In conventional processes, the discarded residue is contaminated with ammonia and biocide and is therefore not environmentally friendly; the ammonia acts as a fertilizer, causing undesirable growth of plants and algae, and the biocide kills desirable microorganisms and microfauna. Some countries require costly treatments of the residues to reduce the amount of ammonia that is discarded into the environment. These treatments consume high quantities of water,

Additionally, the added ammonia breaks down the proteins contained in the latex. This makes the resulting products, such as rubber gloves and condoms, allergenic for approximately 2% of the global population. In addition, ammonia generates nitrosamines within the material that are carcinogenic.

In addition, ammonia vapor affects the health of people throughout the material generation and manufacturing chain, from the farmer to the worker in the processing plant.

Finally, because of the ammonia, the resulting rubber material has a strong odor that makes it unattractive for applications such as sports shoes, despite its superior mechanical properties. For these applications, the current alternative is to use natural rubber without ammonia, which also results in a rubber with a bad odor due to decomposition. Furthermore, this material requires large quantities of water to be processed.

Additionally, the biocides used to complement traditional preservation treatments generate high levels of environmental contamination.

It is therefore desirable to develop new methods of processing natural rubber latex that are free of ammonia and/or biocides that contaminate the environment, or that don't require costly treatments that remove ammonia and biocides before the residues are discarded into the environment. Preferably, such methods would produce rubber having equivalent or superior physical, chemical, and mechanical properties, as well as rubber and latex with fewer allergenic proteins, as compared to conventional, ammonia-treated rubber.

### SUMMARY

In one aspect, provided herein is a method of processing natural latex without the use of ammonia, the method comprising a stabilization step wherein a liquid latex composition is contacted with a stabilizing agent comprising a surfactant selected from the group consisting of alkylbenzene sulfonates, fatty acid alcohols, and ethoxylated fatty acid alcohols.

In another aspect, provided herein is a method comprising one or more of the following steps: (a) a collection step wherein liquid latex is collected from a plant and, preferably, is filtered to remove impurities from the environment; (b) a stabilization step wherein a liquid latex composition is refrigerated and/or contacted with a stabilizing agent; (c) a preservation step wherein the liquid latex composition is contacted with a preserving agent; (d) a pH adjustment step wherein the liquid latex composition is contacted with a pH adjusting agent; (e) a storage step wherein the liquid latex composition is stored for a period of time; and (f) a coagulation step wherein the liquid latex composition is contacted with a coagulation agent, thereby forming a solid latex composition.

Also provided herein is an ammonia-free latex composition. In some embodiments, the composition is produced by a method as provided herein.

Other objects and features of the invention will be in part apparent and in part pointed out hereinafter.

### BRIEF DESCRIPTION OF THE DRAWINGS

FIG. 1 is a graphical depiction of the NETZSCH DMA device used for the double shear testing experiments as described in Example 10.

FIG. 2 is a graphical depiction of a cross-section of the device of FIG. 1 and illustrates the cyclical testing in double shear as described in Example 10.

FIG. 3 depicts the stress behavior observed during dynamic testing at 30% double shear strain at 1 Hz and 21° C., as described in Example 10.

FIG. 4 depicts the normalized stress behavior observed during dynamic testing at 30% double shear strain at 1 Hz and 21° C., as described in Example 10.

FIG. 5 depicts the stress behavior observed during dynamic testing at 50% double shear strain at 1 Hz, as described in Example 10.

FIG. 6 depicts the normalized stress behavior observed during dynamic testing at 50% double shear strain at 1 Hz and 21° C., as described in Example 10.

FIG. 7 is a graphical depiction of a NETZSCH Eplexor® 500 N DMA device used in a relaxation test, as described in Example 11.

FIG. 8 depicts the stress behavior observed during relaxation testing at 30% strain and 21° C., as described in Example 11.

FIG. 9 depicts the normalized stress behavior observed during relaxation testing at 30% strain and 21° C., as described in Example 11.

FIG. 10 depicts the stress response observed during relaxation at 30% elongational strain and at two distinct temperatures, 21° C. and 50° C., as described in Example 11.

FIG. 11 depicts the normalized stress response observed during relaxation at 30% elongational strain and at two distinct temperatures, 21° C. and 50° C., as described in Example 11.

FIG. 12 depicts the stress behavior observed during relaxation testing at 30% strain, and at 3 distinct temperatures (21° C., 50° C. and 80° C.), as described in Example 11.

FIG. 13 depicts the normalized stress behavior observed during relaxation testing at 30% strain, and at 3 distinct temperatures (21° C., 50° C. and 80° C.), as described in Example 11.

FIG. 14 depicts the stress behavior observed during relaxation testing at 50% strain and at 21° C., as described in Example 11.

FIG. 15 depicts the normalized stress behavior observed during relaxation testing at 50% strain and at 21° C., as described in Example 11.

FIG. 16 is an illustration of an 180° peel strength test described in Example 12, which was conducted according to ASTM Standard F2256.

FIG. 17 depicts peel strength test results for Glue Composition A and a commercially available polyvinyl acetate-based glue.

FIG. 18 depicts peel strength test results for Glue Composition B and three commercially available leather glues. Glue 1 is an ammoniated natural rubber adhesive, Glue 2 is a solvent-based leather adhesive with an ethyl acetate, heptane and cyclohexane composition, and Glue 3 is a solvent-based leather adhesive with an ethyl acetate, acetone, solvent naphtha and zinc oxide composition.

FIG. 19 is an illustration of the shear strength test method for flooring and carpet adhesives described in Example 13, which was conducted according to ASTM Standard D6004.

FIG. 20 depicts shear strength test results for Glue Composition B and a commercially available carpet solvent-based adhesive with an n-hexane, toluene and naphthalene composition.

FIG. 21 depicts geometries of a stacking gel and a resolving gel, where the stacking gel houses the sample wells.

FIG. 22 depicts the electrophoresis process where an electric current forces molecules to travel from the cathode toward the anode side.

FIG. 23 depicts a graph resulting from electrophoresis testing performed on the approximately 35% dry rubber content liquid latex samples, i.e., ammoniated latex, additive-free field latex, Alfapreno and Betapreno.

FIG. 24 depicts an image and graph resulting from electrophoresis testing performed on the approximately 60% dry rubber content centrifuged liquid latex samples, i.e., Alfapreno, Betapreno, and two ammoniated latex samples.

### DETAILED DESCRIPTION

Provided herein are methods for processing natural rubber, also referred to as latex, without the use of ammonia.

The ammonia-free methods described herein provide several advantages over traditional latex processing methods. For example, the methods described herein do not require exposing workers to ammonia liquid or vapor, and are therefore much less hazardous to the health of persons involved in the production, treatment, and handling of natural rubber. Additionally, the waste products of the present process are ammonia-free, and therefore are significantly less harmful to the environment than the byproducts of traditional ammonia-based processing, and don't contain pesticides, biocides or microbicides.

In preferred embodiments, the methods described herein may produce liquid latex having a shelf life of a year or longer (e.g., at least two years, at least three years, or even longer), which is significantly longer than traditional ammonia-treated liquid latex. As used herein, the term “shelf life” refers to the period of time for which a product may be stored under ambient conditions (i.e., in the absence of refrigeration or freezing) without exhibiting significant degradation or change in its physical or chemical properties.

Likewise, the ammonia-free rubber compositions described herein exhibit several advantages over traditional, ammonia-treated rubber. For example, the methods described herein produce a liquid latex composition that is non-allergenic (due to the absence of added ammonia). Latex produced according to the methods described herein does not exhibit the strong odors characteristic of added ammonia, making it more attractive for use in consumer-facing applications such as athletic footwear. Additionally, ammonia-free rubber produced according to the methods described herein is purer and with clearer color than traditional ammonia-treated rubber, and is consequently more attractive for use in medical applications. Moreover, the inventive ammonia-free rubber has superior physicochemical characteristics compared with traditional, ammonia-treated rubber.

As will be described in further detail below, the methods provided herein may comprise one or more of the following steps: (a) a collection step wherein liquid latex is collected from a plant and, preferably, is filtered to remove impurities from the environment; (b) a stabilization step wherein a liquid latex composition is refrigerated and/or contacted with a stabilizing agent; (c) a preservation step wherein the liquid latex composition is contacted with a preserving agent; (d) a storage step wherein the liquid latex composition is stored for a period of time; and (e) a coagulation step wherein the liquid latex composition is contacted with a coagulation agent, thereby forming a solid latex composition.

### Components

The methods provided herein may utilize one or more of (1) a stabilizing agent; (2) a preserving agent; (3) a pH adjustment agent; and (4) a coagulating agent. These components are described in further detail below.

### Stabilizing Agent

The methods provided herein may utilize a stabilizing agent. The stabilizing agent acts to stabilize and preserve the latex in liquid form (i.e., to prevent coagulation). Advantageously, the stabilizing agent does not comprise ammonia.

The stabilizing agent may comprise a surfactant. The surfactant may be, for example, an anionic or nonionic surfactant. For example, the stabilizing agent may comprise one or more surfactants selected from the group consisting of alkylbenzene sulfonates, fatty acid alcohols, and ethoxylated fatty acid alcohols.

Non-limiting examples of suitable stabilizing agents include methanesulfonic acid, paratoluene sulfonic acid, 2-sulfoacetic acid, 2-naphthalensulfonic acid, 2-anthracensulfonic acid, p-methylbenzenesulfonic acid, 4-amino-2,3-dichlorobenzenesulfonic acid, benzenesulfonic acid, 1-phenanthanesulfonic acid, phenolsulfonic acid, ethanesulfonic acid, propanesulfonic acid, butanesulfonic acid, pentanesulfonic acid, hexanesulfonic acid, heptanesulfonic acid, octanesulfonic acid, nonanesulfonic acid, decanosulfonic acid, isopropanesulfonic acid, terbutanesulfonic acid, benzenesulfonic acid, ortho-toluenesulfonic acid, dodecylbenzene sulfonic acid, methylbenzene sulfonic acid, tertbutyl sulfonic acid, propylbenzene sulfonic acid, methylbenzene sulfonic acid, ethylbenzene sulfonic acid, butylbenzene sulfonic acid, pentylbenzene sulfonic acid, hexylbenzene sulfonic acid, heptylbenzene sulfonic acid, octylbenzene sulfonic acid, nonylbenzene sulfonic acid, decabenzene sulfonic acid, undecabenzene sulfonic acid, trifluoromethanesulfonic acid, 10-camphorsulfonic acid, metasulfonic acid, xylenesulfonic acid, lauric alcohol, ethoxylated lauric alcohol, ethoxylated long chain alcohols having from 7 to 15 carbons, and mixtures or combinations thereof. Generally, the surfactant may be aqueous or anhydrous. For example, the stabilizing agent may comprise an ethoxylated lauric alcohol. As a further example, the stabilizing agent may comprise a dodecylbenzene sulfonic acid.

### Preserving Agent

The methods provided herein may utilize a preserving agent. The preserving acts to preserve the latex and prevent its degradation by bacteria or other microorganisms or microfauna. Advantageously, the preserving agent does not comprise ammonia.

The preserving agent may comprise an acid. For example, the preserving agent may comprise a halogenated acid. Non-limiting examples of suitable preserving agents include hydrochloric acid, hydrofluoric acid, iodic acid, and hydrobromic acid. Generally, the acid may be aqueous or anhydrous. For example, the preserving agent may comprise hydrofluoric acid.

Without being bound to a particular theory, it is believed that addition of a halogenated acid acts to replace the hydrogen sulfide present in the cysteine of the peptides and/or proteins in natural latex sap, and that this process acts to preserve the natural latex in its liquid form and prevent degradation by microorganisms.

### pH Adjustment Agent

The methods provided herein may utilize a pH adjustment agent. The pH adjustment agent may be used, if necessary, to increase the pH of the liquid latex composition to a range of from about 6 to about 10, which is optimal for the storage stability of the composition.

Non-limiting examples of suitable pH adjustment agents include sodium hydroxide, potassium hydroxide, amines, and mixtures or combinations thereof.

### Coagulating Agent

The methods provided herein may utilize a coagulating agent. The coagulating agent, which may also be referred to herein as a synthesizing agent, acts to coagulate the liquid latex, thereby producing a solid latex composition.

The coagulating agent may comprise an alcohol. For example, the coagulating agent may comprise a C₁ to C₈ alcohol, more preferably a C₁ to C₆ alcohol. Non-limiting examples of suitable coagulating agents include methanol, ethanol, n-propanol, benzyl alcohol, isopropyl alcohol, isobutyl alcohol, tertiary butyl alcohol, pentanol, hexanol, heptanol, octanol, and mixtures or combinations thereof. Generally, the alcohol may be aqueous or anhydrous. For example, the coagulating agent may comprise ethanol.

### Methods for Preparing Latex Compositions

The methods provided herein may comprise one or more of the following steps: (a) a collection step wherein liquid latex is collected from a plant and is filtered to remove all impurities from the environment; (b) a stabilization step wherein a liquid latex composition is refrigerated and/or contacted with a stabilizing agent; (c) a preservation step wherein the liquid latex composition is contacted with a preserving agent; (d) a pH adjustment step wherein the liquid latex composition is contacted with a pH adjusting agent; (e) a storage step wherein the liquid latex composition is stored for a period of time; and (f) a coagulation step wherein the liquid latex composition is contacted with a coagulation agent, thereby forming a solid latex composition. These steps are described in further detail below.

### Collection Step

The methods provided herein may optionally comprise a collection step wherein natural liquid latex is collected from a plant.

The collection step may comprise filtering the natural liquid latex to remove foreign objects and contaminants. For example, the natural liquid latex may be filtered using a sieve or mesh having a pore size of about 5 mm or less, about 4 mm or less, about 3 mm or less, about 2 mm or less, or about 1 mm or less.

Optionally, the natural liquid latex may be stored for a period of time prior to the stabilization step. For example, the natural liquid latex may be stored for a period of from 0 hours to about 10 hours prior to the stabilization step.

### Stabilization Step

The methods provided herein may comprise a stabilization step wherein a liquid latex composition is contacted with a stabilizing agent, thereby providing a stabilized liquid latex composition. The liquid latex composition may comprise, for example, a natural liquid latex that has been collected from a plant, and optionally filtered, as described above.

The stabilization step may comprise adding the stabilizing agent in an amount of from about 0.1% to about 30% by volume, and more typically in an amount of from about 0.5% by volume to about 5% by volume, relative to the initial volume of the liquid latex composition. For example, the stabilizing agent may be added in an amount of at least about 0.1% by volume, at least about 0.2% by volume, at least about 0.5% by volume, at least about 1.0% by volume, at least about 1.5% by volume, or at least about 2.0% by volume relative to the initial volume of the liquid latex composition. In preferred embodiments, the stabilizing agent is added in an amount of from about 0.5% to about 3% by volume, for example about 0.5% to about 2.5%, or from about 1% to about 2% by volume relative to the initial volume of the liquid latex composition.

Alternatively, in some embodiments, the stabilization step may comprise refrigerating the liquid latex composition. For example, the stabilization step may comprise refrigerating the latex composition at a temperature of no greater than about 5° C. for a period of at least about 12 hours.

The stabilization step may comprise refrigerating the liquid latex composition at a temperature no greater than about 4° C., or no greater than about 3° C. The stabilization step may comprise refrigerating the liquid latex composition for a period of at least about 16 hours, at least about 20 hours, at least about 24 hours, at least about 30 hours, at least about 36 hours, or at least about 48 hours.

When the liquid latex composition comprises natural latex collected from a plant, and the stabilization step comprises refrigerating the liquid latex composition, the method preferably comprises initiating the stabilization step prior to about 72 hours after the natural latex is collected from the plant. For example, the stabilization step is preferably initiated prior to about 48 hours, prior to about 36 hours, prior to about 30 hours, prior to about 24 hours, prior to about 16 hours, prior to about 12 hours, or even prior to about 8 hours after the natural latex is collected from the plant.

Optionally, the stabilization step may comprise both refrigerating the liquid latex composition and contacting the liquid latex composition with a stabilizing agent as described above.

### Preservation Step

The methods provided herein may optionally comprise a preservation step wherein the liquid latex composition is contacted with a preserving agent, thereby providing a preserved liquid latex composition. A liquid latex composition that has been both stabilized and preserved is referred to herein as a “stabilized and preserved” liquid latex composition.

The stabilization step and the preservation step may be carried out in either order, or simultaneously. In some cases, the stabilizing agent also acts as a preserving agent, and so the addition of a further preserving agent is not necessary. For example, a separate preservation step may be unnecessary when the stabilizing agent is an alkylbenzene sulfonate (for example, a dodecylbenzene sulfonic acid), and/or when the stabilizing agent is present in an amount of greater than about 1% by volume of the liquid latex composition. In such cases, the stabilizing agent also functions as a preserving agent as described herein.

The preservation step may comprise adding the preserving agent in an amount of from about 0.05% to about 30% by volume, and more typically in an amount of from about 0.1% by volume to about 5% by volume, relative to the initial volume of the liquid latex composition. For example, the preserving agent may be added in an amount of at least about 0.05% by volume, at least about 0.1% by volume, at least about 0.2% by volume, at least about 0.5% by volume, at least about 1.0% by volume, at least about 1.5% by volume, or at least about 2.0% by volume relative to the initial volume of the liquid latex composition. In preferred embodiments, the preserving agent is added in an amount of from about 0.05% to about 2% by volume, for example from about 0.05% to about 1%, or from about 0.1% to about 0.5% by volume relative to the initial volume of the liquid latex composition.

### pH Adjustment Step

The methods provided herein may optionally comprise a pH adjustment step wherein the liquid latex composition is contacted with a pH adjusting agent.

Liquid latex compositions typically have a pH of between about 6 and about 10, which is optimal for their shelf stability. However, following the preservation step, the pH of the liquid latex composition may be below the desired range (e.g., from about 3 to about 5). In such cases, it is desirable to carry out a pH adjustment step wherein the liquid latex composition is contacted with a pH adjustment agent in an amount sufficient to bring the pH of the liquid latex composition to the desirable range (i.e., from about 6 to about 10).

### Storage Step

The methods provided herein may optionally comprise a storage step wherein a stabilized and preserved liquid latex composition is stored for a period of time prior to coagulation.

The composition may be stored for a period of at least about 1 day, at least about 1 week, at least about 2 weeks, at least about 3 weeks, at least about 4 weeks, at least about 1 month, at least about 2 months, at least about 3 months, at least about 6 months, at least about 1 year, at least about 2 years, or even at least about 3 years, or more.

### Coagulation Step

The methods provided herein may optionally comprise a coagulation step wherein the liquid latex composition is contacted with a coagulating agent, thereby forming a solid latex composition.

The coagulation step may comprise adding the coagulating agent in an amount of from about 0.5% to about 50% by volume, relative to the initial volume of the liquid latex composition. For example, the coagulating agent may be added in an amount of at least about 1% by volume, at least about 5% by volume, at least about 10% by volume, at least about 15% by volume, at least about 20% by volume, at least about 25% by volume, or at least about 30% by volume relative to the initial volume of the liquid latex composition. In preferred embodiments, the coagulating agent is added in an amount of from about 10% to about 50% by volume, for example about 15% to about 40%, or from about 20% to about 40% by volume relative to the initial volume of the liquid latex composition.

### Preserved and Stabilized Liquid Latex Compositions

Also provided herein is an ammonia-free preserved and stabilized liquid latex composition. In some embodiments, the composition is produced by a method as described above.

For example, the preserved and stabilized liquid latex composition may comprise (a) latex; (b) a stabilizing agent, which may be selected as described above; and (c) optionally, a preserving agent, which may be selected as described above.

The preserved and stabilized liquid latex composition preferably comprises natural latex. Typically, the composition comprises latex in an amount of from about 80% by volume to about 99% by volume. For example, the preserved and stabilized liquid latex composition may comprise latex in an amount of at least about 80% by volume, at least about 85% by volume, at least about 90% by volume, at least about 95% by volume, at least about 96% by volume, at least about 97% by volume, at least about 98% by volume, or at least about 99% by volume.

Typically, the preserved and stabilized liquid latex composition comprises the stabilizing agent in an amount of from about from about 0.1% to about 30% by volume, and more typically in an amount of from about 0.5% by volume to about 5% by volume. For example, the composition may comprise the stabilizing agent in an amount of at least about 0.1% by volume, at least about 0.2% by volume, at least about 0.5% by volume, at least about 1.0% by volume, at least about 1.5% by volume, or at least about 2.0% by volume.

Typically, the preserved and stabilized liquid latex composition comprises the preserving agent in an amount of from about from about 0.1% to about 30% by volume, and more typically in an amount of from about 0.5% by volume to about 5% by volume. For example, the composition may comprise the preserving agent in an amount of at least about 0.05% by volume, at least about 0.1% by volume, at least about 0.2% by volume, at least about 0.5% by volume, at least about 1.0% by volume, at least about 1.5% by volume, or at least about 2.0% by volume.

The stabilized ammonia-free liquid latex composition provided herein is more stable than its ammonia-based counterpart. The rheological properties of the compositions provided herein remain constant over time (e.g., for at least two years, at least three years, or even longer) when stored at room temperature. On the other hand, rheological properties of ammonia-based latex significantly change over time, affecting processability and handling. Depending on the ammonia content, the viscosity of ammonia-based liquid latex can double (0.35% weight of ammonia) or even increase by a factor of 6 (0.8% weight of ammonia) over a 45 day period. The shelf life of ammonia-based liquid latex is at most 4 months, at which point it begins to decompose.

Furthermore, ammonia-free solid rubber produced using the methods provided herein exhibit a significant improvement in mechanical properties. These increases in mechanical properties can lead to material reduction during manufacture, which not only reduces cost but also results in lighter products. This is particularly advantageous in applications such as the manufacturing of athletic shoes, where strong and lightweight materials are highly desirable.

### Solid Rubber Compositions

Also provided herein is an ammonia-free solid rubber composition. Preferably, the composition is produced by a method as described above. For example, the solid rubber composition may be prepared by contacting a preserved and stabilized liquid latex composition as described above with a coagulating agent.

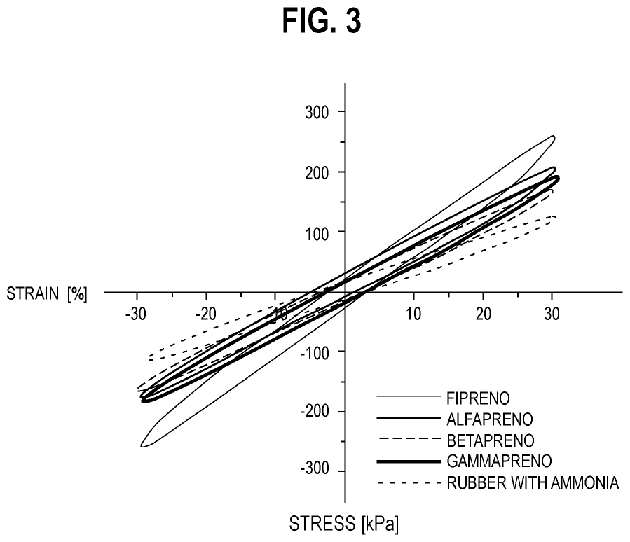

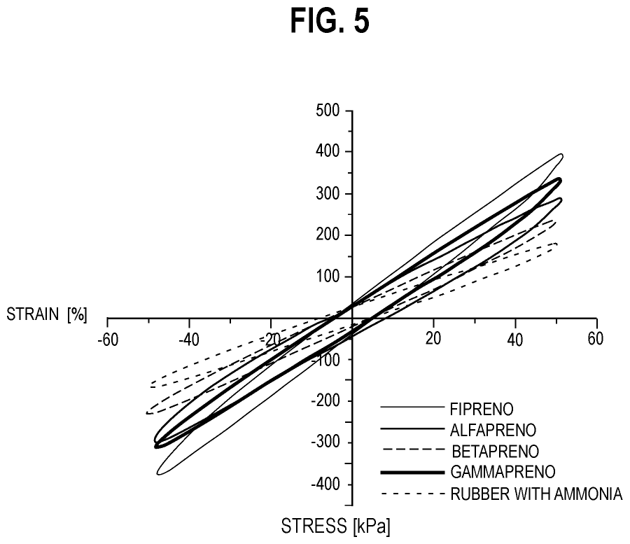

Dynamic mechanical measurements, presented in FIGS. 3 and 5, show that the ammonia-free solid rubber produced using the methods described herein exhibit a significant improvement in mechanical properties. A relaxation test, where a 30% shear strain is imposed on a thin rubber sample, exhibits a stress that is at least twice as the stress observed with ammonia-based natural rubber. A formulation which is described as “Betapreno” in the example below has a stress that is 2.3 times higher than the ammonia-based system. The formulations called Alfapreno and Gammapreno, presented below, are on average 1.8 times stiffer than the ammonia-based counterparts.

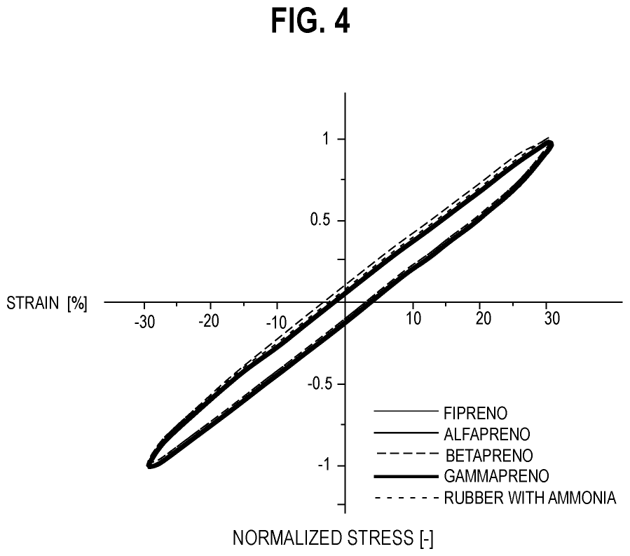

It is also important to note that solid rubber compositions prepared as described herein had a higher mechanical performance when tested dynamically using a sinusoidal 30% strain input. The stress exhibited by Alfapreno during the dynamic test increased by a factor of 1.6, Gammapreno increased by a factor of 1.5 and Betapreno increased by a factor of 1.3 when compared to ammonia-based natural rubber (FIG. 3). The overall damping and hysteresis effects of the new rubber ammonia-free formulations is the same with all rubber formulations, as shown in the normalized curves presented in FIG. 4. Hence, effects during product usage, such as automotive tire heating during use, remain unaffected.

### Examples

The following non-limiting examples are provided to further illustrate the present disclosure.

### Example 1: Synthesis of Alfapreno

A stabilized and preserved liquid latex composition was prepared by combining: 98.6 volume % of filtered raw latex; 1.0 volume % of ethoxylated lauric alcohol (7 moles); and (c) 0.4 volume % of a mixture of 50% hydrofluoric acid and 50% water.

The stabilized and preserved latex was stored for two months without observed degradation. A solid rubber composition was then created by adding 300 mL ethyl alcohol to 1 L of the stabilized and preserved liquid latex.

### Example 2: Synthesis of Deltapreno

A stabilized and preserved liquid latex composition was prepared by combining: 98.6 volume % of filtered raw latex; 1.0 volume % of a mixture of 50% ethoxylated lauric alcohol (3 moles) and 50% ethoxylated lauric alcohol (7 moles) with a molar average of 5 moles; and 0.4 volume % of a mixture of 50% hydrofluoric acid and 50% water.

The stabilized and preserved latex was stored for two months without observed degradation. A solid rubber composition was then created by adding 300 mL ethyl alcohol to 1 L of the stabilized and preserved liquid latex.

### Example 3: Synthesis of Gammapreno

A stabilized and preserved liquid latex composition was prepared by combining: 98.6 volume % of filtered raw latex; 1 volume % of ethoxylated lauric alcohol (9 moles); and 0.4 volume % of a mixture of 50% hydrofluoric acid and 50% water.

The stabilized and preserved latex was stored for two months without observed degradation. A solid rubber composition was then created by adding 300 mL ethyl alcohol to 1 L of the stabilized and preserved liquid latex.

### Example 4: Synthesis of Omegapreno

A stabilized and preserved liquid latex composition was prepared by combining: 98.6 volume % of filtered raw latex; 1 volume % of ethoxylated lauric alcohol (10 moles); and 0.4 volume % of a mixture of 50% hydrofluoric acid and 50% water.

The stabilized and preserved latex was stored for two months without observed degradation. A solid rubber composition was then created by adding 300 mL ethyl alcohol to 1 L of the stabilized and preserved liquid latex.

### Example 5: Synthesis of Epsilonpreno

A stabilized and preserved liquid latex composition was prepared by combining: 98.6 volume % of filtered raw latex; 1 volume % of ethoxylated lauric alcohol (12 moles); and 0.4 volume % of a mixture of 50% hydrofluoric acid and 50% water.

The stabilized and preserved latex was stored for two months without observed degradation. A solid rubber composition was then created by adding 300 mL ethyl alcohol to 1 L of the stabilized and preserved liquid latex.

### Example 6: Synthesis of Thetapreno

A stabilized and preserved liquid latex composition was prepared by combining: 98.6 volume % of filtered raw latex; 1 volume % of ethoxylated lauric alcohol (18 moles); and 0.4 volume % of a mixture of 50% hydrofluoric acid and 50% water.

The stabilized and preserved latex was stored for two months without observed degradation. A solid rubber composition was then created by adding 300 mL ethyl alcohol to 1 L of the stabilized and preserved liquid latex.

### Example 7: Synthesis of Betapreno

A stabilized and preserved liquid latex composition was prepared by combining: 98.0 volume % of filtered raw latex; and 2.0 volume % of linear dodecylbenzene sulfonic acid.

The stabilized and preserved latex was stored for two months without observed degradation. A solid rubber composition was then created by adding 300 mL ethyl alcohol to 1 L of the stabilized and preserved liquid latex.

### Example 8: Synthesis of Fipreno

A stabilized and preserved liquid latex composition was prepared by storing 100.0 volume % of filtered raw latex at 3° C. for twenty-four (24) to forty-eight (48) hours, after which a solid rubber composition was then created by adding 300 mL ethyl alcohol to 1 L of the stabilized and preserved liquid latex.

### Example 9: Materials and Sample Preparation

The following materials and preparation steps were used to prepare samples for use in the testing methods described further below.

Samples of ammonia-free natural rubber (NR) materials (Alfapreno, Betapreno, Gammapreno, Fipreno) produced in Victoria, Colombia, were used for the mechanical characterization. The corrugated sheets of natural rubber were compressed in between two aluminum plates, previously cleaned with Acetone, and placed in the YAMATO Convection Oven at 70° C. for 4 hours to ensure full relaxation between plates and proper molding of a flat specimen. After compression molding of the flat raw natural rubber sheets, a 7.50 mm wide rectangular die was used to cut out relaxation testing specimen from the sheet to ensure all samples had the same cross-sectional area. Similarly, a cylindrical 10 mm in diameter die was used to cut out double shear testing specimen from the sheet to ensure all samples had the same cross-sectional area.

### Example 10: Dynamic Measurements in Double Shear

### Test Methods

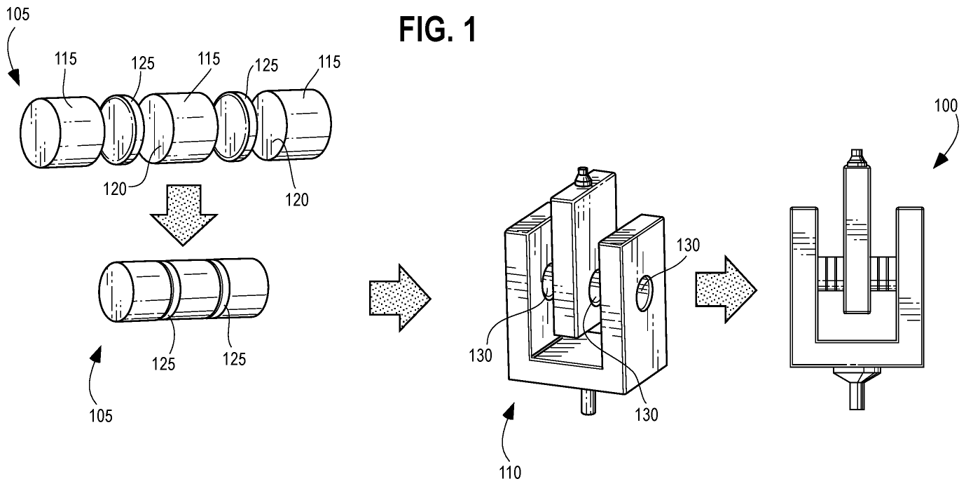

A NETZSCH Eplexor® 500 N Dynamic Mechanical Analyzer (DMA) was employed for the characterization of Lissajous curves and tan (delta) for each specific sample. The NETZSCH DMA is a dynamic analyzer capable of achieving high forces (up to 500 Newtons, compared to at most 20 Newtons of common DMA devices) and able to perform both transient and dynamic testing within a frequency range of 0.01 Hz and 100 Hz. The instrument is also capable of testing within a temperature range of 20° C. and 500° C. It is important to note that single shear testing creates a moment load on the sample and is not representative of pure shear. For that reason, we used the NETZCH DMA device to eliminate the moments and to rely purely on a shear-driven load. FIG. 1 includes a graphical depiction of a selected portion of the NETZCH DMA (illustrated as a device 100), as used in the following examples.

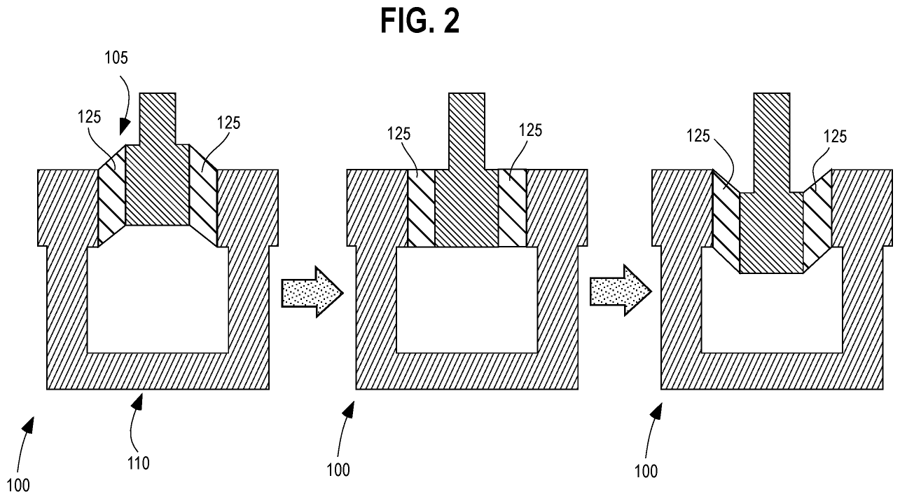

The arrows in FIG. 1 illustrate the general process via which a sample can be loaded into the device 100 for testing. The device 100 comprises a sample loading implement 105 (the “implement 105”) that is removably couplable to a double shear fixture 110. The implement 105 comprises cylindrical receptacles 115 having surfaces 120 onto which a sample 125 can be adhered, affixed, or otherwise coupled to. Once the sample 125 is coupled to the surfaces 120, and the individual cylindrical receptacles 115 of the implement 105 are joined or coupled together, the implement 105 may be inserted or received into the double shear fixture 110. More particularly, the implement 105 may be positioned through bores 130 of the double shear fixture 110. As illustrated in FIG. 2, after the implement 105 is received in the double shear fixture 110, the device 100 can impose a pure shear load on the sample 125 via an oscillatory motion (e.g., by forcing the sample 125 to repeatedly move a predetermined distance in an upwards direction and a downwards direction).

To achieve as perfect a shear loading as possible, the sample thickness within the shearing gap was maintained between 1 mm-2 mm. For each example, the sample was adhered between cylindrical receptacles using cyanoacrylate adhesive to achieve the highest possible stability of bond with the contact surfaces. After two cylindrical samples (diameter=mm, and thickness=1.5 mm) were attached to the metal receptacles pressure was applied to ensure proper adhesion and to eliminate air bubbles trapped between the sample and metal surface. The samples were left for 24 hours at room temperature to ensure the adhesive achieved full cure. 10

Once fully cured, the cylindrical specimen was inserted into the double shear fixture wherein an oscillatory motion imposed a pure shear load on both rubber samples. This study focuses on testing the materials at 30% and 50% shear strain at 1 Hz.

### Observations of Material Behavior

Evaluation of the Lissajous curve extracted from cyclical testing allows for the determination of how much damping a material exhibits during deformation and how non-linear the material's viscoelastic behavior is. A sign that the material behaves in a linear viscoelastic fashion is that the Lissajous curves remain elliptical. The damping of the material is characterized by a property named tan (delta). The wider the ellipse, the larger the tan (delta). A very narrow ellipse that approaches a line means little to no damping with a tan (delta) of zero. A wide ellipse that approaches a circle is a material with only damping and no elasticity with a tan (delta) that approaches infinity. The equation below defines tan (delta) as the ratio between the Loss Modulus (damping) and Storage Modulus (elastic component), which gives insight to how much energy is lost and dissipated during dynamic loading.

$$tan δ = \frac{{E}^{″}}{{E}^{′}} = \frac{Loss Modulus}{Storage Modulus}$$

Upon analysis of the 30% strain Lissajous curve, it can be seen in FIG. 3 that ammonia-free rubber materials are much stiffer than of a material processed with ammonia, as Fipreno reaches a maximum stress of 258 kPa and the rubber process with ammonia reaches 124 kPa for 30% double shear testing at 1 Hz.

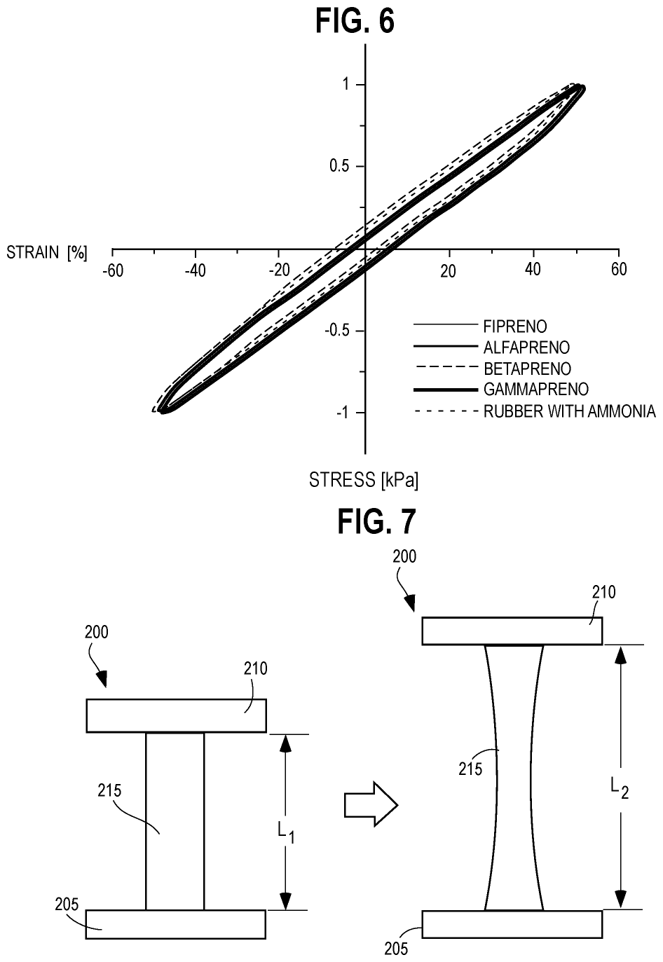

Normalizing the curves from FIG. 3 results in FIG. 4, where a shape analysis of the curve is possible. It can be seen from such plot that the width of the curve for each material is very similar, indicating that all materials have a similar tan (delta). Similarly, to 30% testing, 50% testing results in similar trends that ammonia-free rubber materials exhibit higher stresses and that they result in similar tan (delta) values to a rubber process with ammonia (see FIGS. 5 and 6). This means that while the ammonia-free samples are stiffer than the rubber containing ammonia, the fundamental viscoelastic behavior is the same for the ammonia and the ammonia-free rubber materials.

### Example 11: Relaxation Measurements in Tension

### Test Methods

Similarly to the dynamic testing, relaxation behavior was characterized with the NETZSCH Eplexor® 500 N DMA by imposing a 10%, 30%, and 50% tensile static strain for 10 minutes and logging the stress response from the material with respect to time. Capturing the temperature-dependent behavior was done by testing at 21° C., 50° C., and at 80° C. Furthermore, each sample had a cross-sectional area of 22.65 mm² and the clamping distance, or sample length for the 10%, 30%, and 50% tests were 20 mm, 20 mm, and 15 mm, respectively. The clamping distance for the 50% test was slightly smaller due to the limitation of travel length of the DMA. The equation below defines elongational strain while FIG. 7 depicts the relaxation test set up.

$$Strain [ \% ] = \frac{{L}_{final} - {L}_{initial}}{{L}_{initial}}$$

More specifically, FIG. 7 illustrates a graphical representation of a selected portion of the NETZSCH Eplexor® 500 N DMA (illustrated here as a device 200) used in the relaxation test. The device 200 comprises a first clamp 205 and a second clamp 210. During testing, the clamps 205, 210 may move towards and away from one another. In addition, a sample 215 may be inserted into the device 200 between the clamps 205, 210 and adhered, affixed, or otherwise coupled to the clamps 205, 210. During testing, as indicated in FIG. 7, the clamps 205, 210 may first be separated by a distance L₁; the clamps 205, 210 may then be moved apart such that the clamps 205, 210 are separated by a distance L₂.

### Observations of Material Behavior

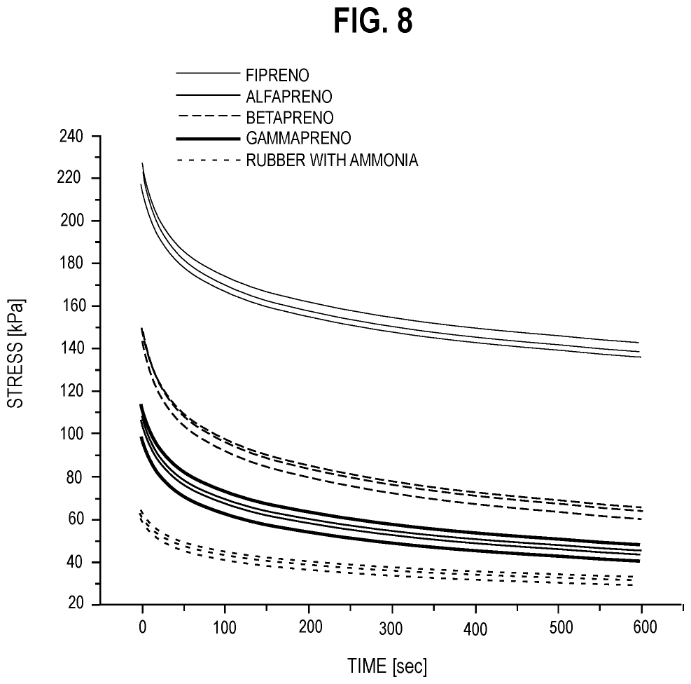

As the static strain is imposed on the sample, the stress experienced by the material increases to its maximum point at which then begins to decay. Relaxation is defined as the time needed for the material to experience 1% of the maximum stress experienced at the start of testing. The ammonia-free materials rubber samples outperformed conventional natural rubber processed with ammonia in terms of relaxation. As seen in FIG. 8, rubber processed with ammonia resulted in a material which is less rigid than the ammonia-free natural rubber and it can be appreciated how Fipreno reaches four times the stresses during relaxation, compared to rubber processed with ammonia. This is a great indication for performance as formulations will require less reinforcements to create a stronger material, or pure materials can be foamed to reduce weight, and yet maintain the same mechanical properties. All four ammonia-free natural rubber materials outperform the conventional natural rubber processed in ammonia in regard to rigidity.

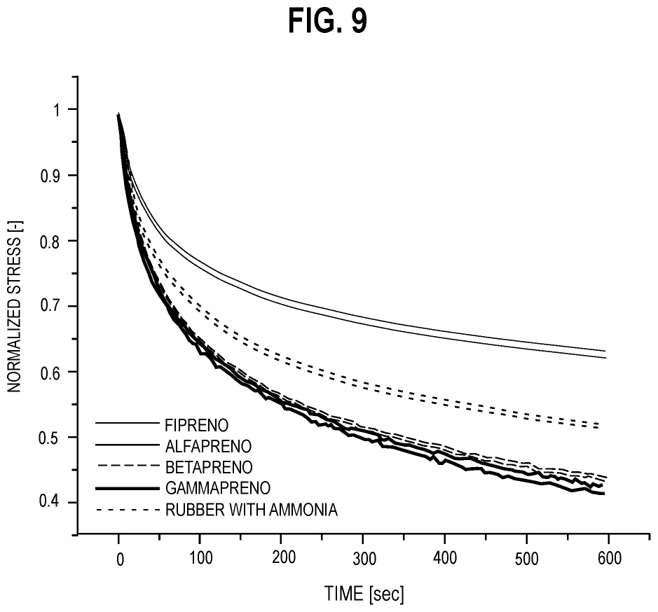

FIG. 9 represents the normalized results from FIG. 8. Normalization of curves allows for the analysis of the relaxation decay behavior and can be seen that the Alfapreno, Betapreno, and Gammapreno have the ability of relaxing much quicker while Fipreno behaves in a more elastic manner, minimizing the relaxation decay behavior.

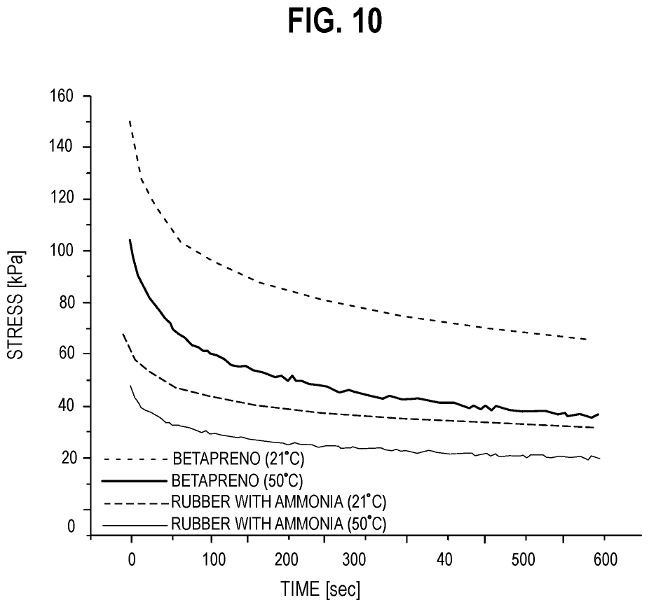

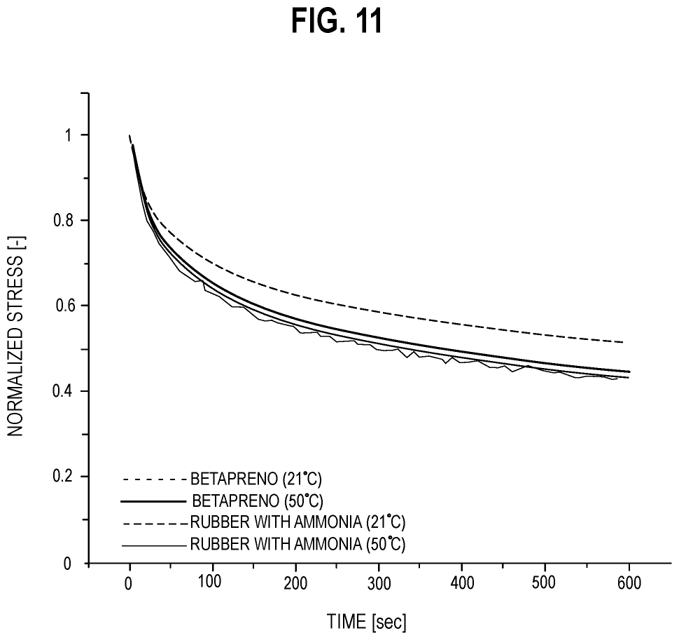

An increase in testing environment temperature increases the free volume between molecules, accelerating relaxation and diminishing the rigidity of the material. Conducting testing at 21° C., 50° C., and 80° C. allows for the analysis of such curves at distinct temperatures and investigating the temperature-dependent behavior of ammonia-free rubber material results in determining that ammonia-free rubber materials' relaxation behavior is less sensitive to temperature change. FIG. 10 shows the comparison of Betapreno and rubber processed with ammonia where it can be seen that an increase in temperature in fact reduces the rigidity of both materials but it is important to note that Betapreno remains stiffer than conventional natural rubber and that the relaxation decay behavior does not change, as seen in FIG. 11.

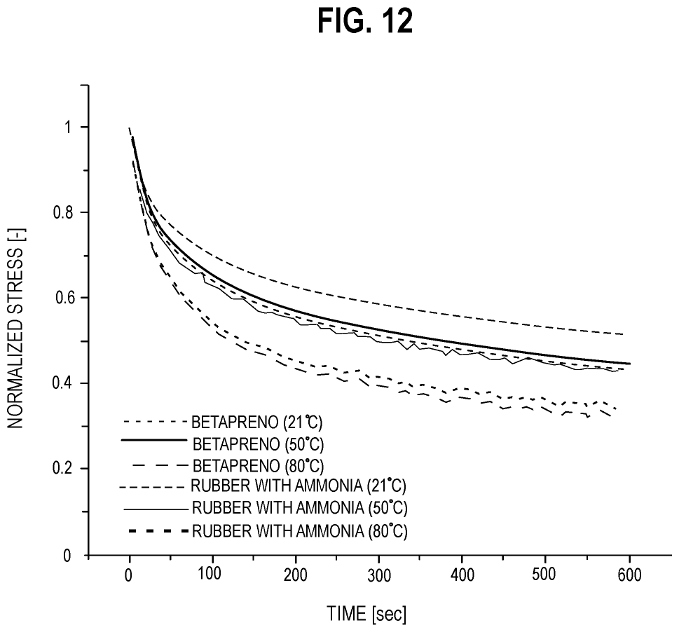

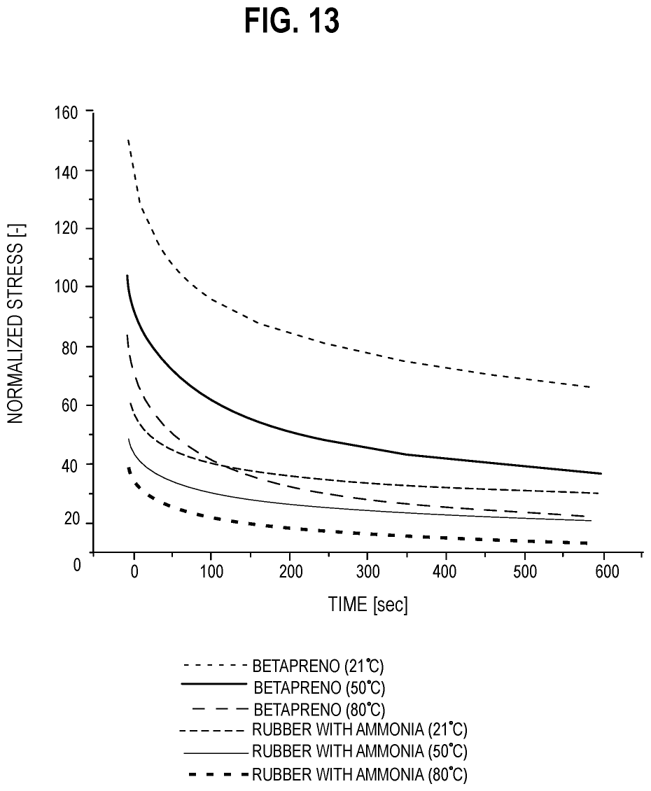

Furthermore, the same statement can be said for testing at 80° C., where it can be seen in FIG. 12 that increasing the temperature from 50° C. to 80° C. results in Betapreno having a slight change in relaxation decay behavior but as seen in FIG. 13, it remains as the most rigid material within the comparison.

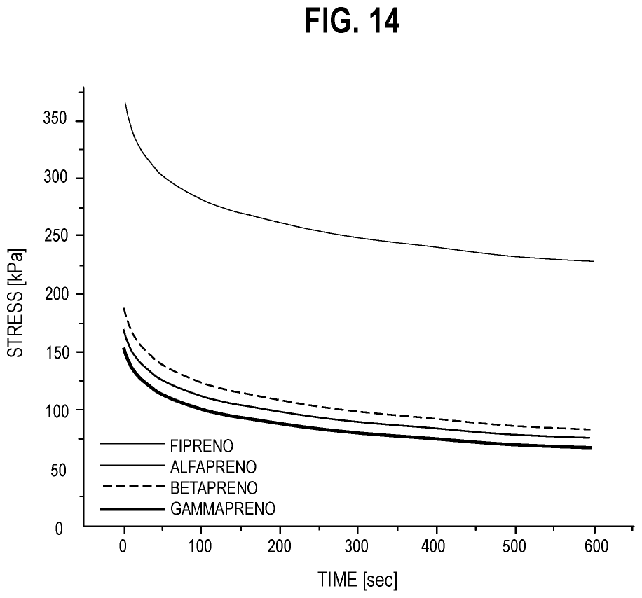

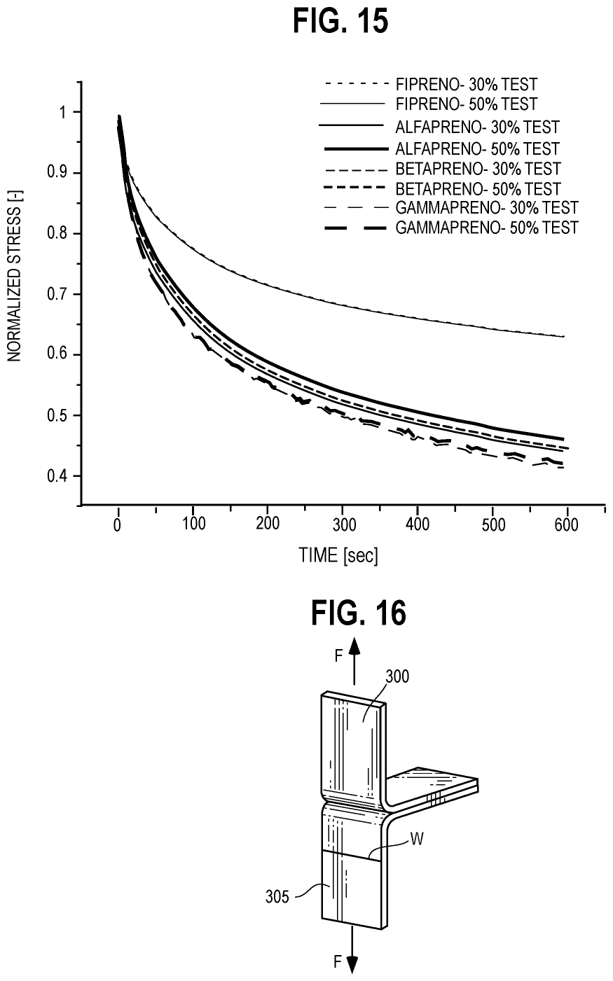

Polymers exhibit time and temperature-dependent behavior, and as large strain-level testing is conducted, the material behaves in a non-linear fashion. Non-linear regimes are crucial for understanding what occurs during real-world applications as strain levels primarily fall within this region. FIG. 14 shows 50% relaxation testing of the ammonia-free materials. It can be appreciated how they all experience much larger stresses, compared to 30% tests in FIG. 13 above. Evaluating the decay behavior of both 30% and 50% testing, as seen in FIG. 15, it can be appreciated that an increase in strain does not alter the relaxation decay behavior. Such minimal influence in decay behavior indicates that the decay is independent of strain applications up to 50% strain.

### Example 12: Ammonia-Free Natural Rubber Glues

Glue compositions comprising ammonia-free natural rubber were prepared as described below.

Glue Composition A (Paper Glue): A glue composition was prepared by mixing an Alfapreno natural rubber composition (99.2% by weight) with hydroxyethyl cellulose (0.8% by weight). The natural rubber composition has a dry rubber content (DRC) of approximately 35%. The resulting composition was useful, for example, as a paper or leather glue.

Glue Composition B (Wood and Leather Glue): A glue composition was prepared by mixing a centrifuged Alfapreno natural rubber composition (99.0% by weight) with hydroxyethyl cellulose (0.5% by weight) and collagen (0.5% by weight). The centrifuged natural rubber composition has a dry rubber content (DRC) of approximately 60%. The resulting composition was useful, for example, as a wood and leather glue.

Glue Compositions A and B were each tested using a 180° peel test, which was conducted according to ASTM Standard F2256. An exemplary illustration of the peel test is provided in FIG. 16. As further described below, a first sheet 300 and a second sheet 305, each having a width W, are separated via the application of forces F to the sheets 300, 305 during the peel test. The forces F were applied to the sheets 300, 305 in the directions indicated by the arrows in FIG. 16.

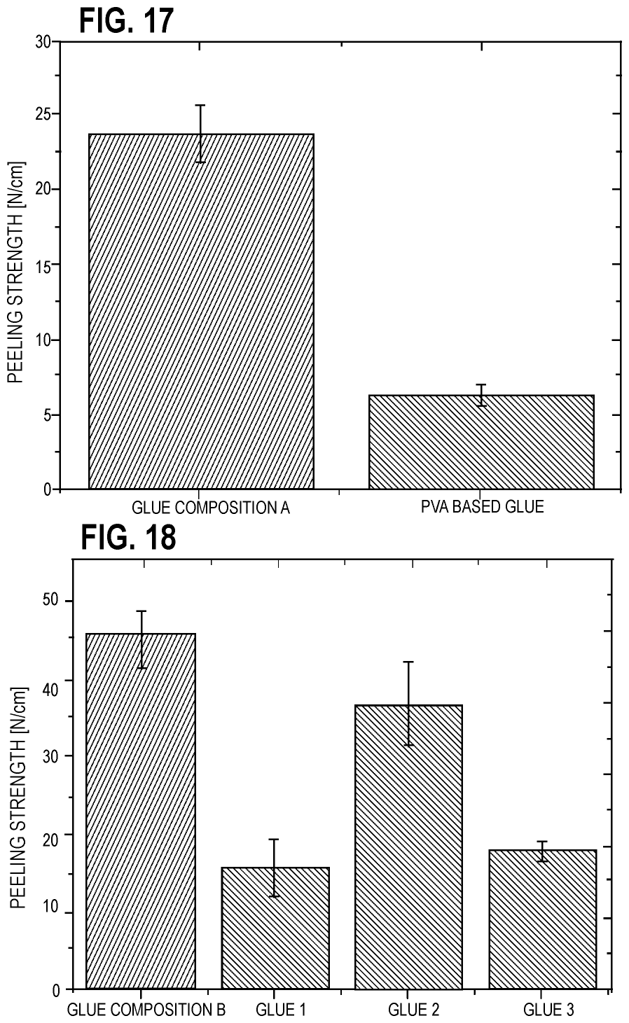

Pursuant to the ASTM F2256 standard, the interfacial toughness of the glue is reported as follows

$$T = \frac{F}{W}$$

where F is the force in Newtons and W the width in centimeters. The specimens were cut from natural grain cow leather sheets to a width W of 2.54 cm (1″). The Glue Composition A peel strength was compared to a commercially available polyvinyl acetate glue, as shown in FIG. 17. Table 1 presents the results. It can be seen that the Glue Composition A, with a peel strength of 23.64 N/cm, had a significantly higher peel strength than the commercial adhesive, that exhibited a peel strength of 6.29 N/cm. Each test was repeated 6 times, and both materials performed in a repeatable manner, with standard deviations of 1.91 and 0.68 N/cm, for Glue Composition A and the PVA based commercial glue, respectively.

TABLE 1
Leather peel test results comparison of glue composition A
(Paper Glue) and a commercially available PVA based glue

| | Peel Strength | Standard |
|---|---|---|
| Adhesive | (N/cm) | Deviation (N/cm) |
| Glue Composition A | 23.64 | 1.91 |
| Elmer's Glue | 6.29 | 0.68 |
| (polyvinyl acetate composition) | | |

The peel strength of Glue Composition B was compared to a commercially available ammoniated natural rubber cement (Glue 1), and two commercially available ethyl acetate, solvent-based leather adhesives (Glue 2 and 3), as shown in FIG. 18. Table 2 presents the results. It can be seen that Glue Composition B, with a peel strength of 44.53 N/cm, had a significantly higher peel strength than the commercially available leather adhesive counterparts. The peel strength of the ammoniated natural rubber cement (Glue 1) was 15.72 N/cm, and the solvent-based ethyl acetate were 17.94 (Glue 2) and 36.63 N/cm (Glue 3), respectively. All tests were repeated 6 times and were repeatable, as reflected by the standard deviations shown in Table 2.

TABLE 2
Leather peel test results comparison of glue composition
B (Wood and Leather Glue) and various commercially available
adhesives used in the shoe manufacturing industry.

| | Peel | Standard |
|---|---|---|
| | Strength | Deviation |
| Adhesive | (N/cm) | (N/cm) |
| Glue Composition B | 44.53 | 4.09 |
| Glue 1 | 15.72 | 3.61 |
| Ammoniated latex adhesive | | |
| Glue 2 | 36.63 | 5.47 |
| Angelus Clear Shoe Cement | | |
| (ethyl acetate, heptane and cyclohexane) | | |
| Glue 3 | 17.94 | 1.21 |
| Pattex Contact Adhesive | | |
| (ethyl acetate, acetone, solvent naphtha, | | |
| zinc oxide) | | |

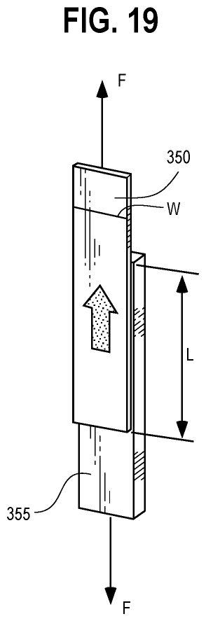

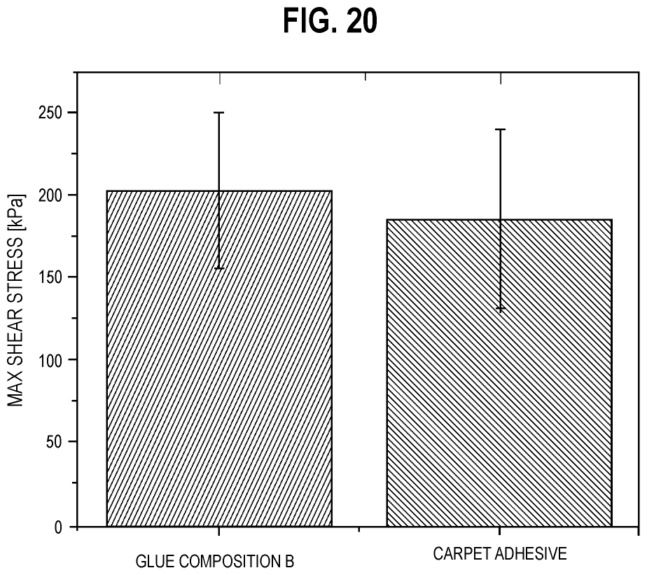

The shear strength of Glue Composition B was compared to a commercially available solvent-based flooring and carpet adhesive, using tests conducted according to ASTM Standard D6004. An exemplary illustration of the shear strength test is provided in FIG. 19, in which a first material 350 (provided here as a carpet backing) and a second material 355 (provided here as plywood) were adhered to one another. During the shear strength test, forces F were applied to the materials 350, 355 in the directions indicated by the arrows in FIG. 19. Pursuant to the ASTM D6004 standard, the interfacial shear strength of the glue is reported as follows

$$S = \frac{F}{L * W}$$

where F is the force in Newtons, W the width of the specimen in meters and L is the length of the specimen bonded to the plywood substrate in meters. The carpet backing test specimens were cut to a 2.54 cm (1″) width and bonded to the plywood. In the tests, W and L were 2.54 cm (1″) and 7.62 cm (3″), respectively. FIG. 20 compares the shear strength of Glue Composition B and the solvent-based flooring and carpet adhesive. Table 3 presents the results. It can be seen that Glue Composition B, with a shear strength of 203.15 kPa, had a higher strength then its commercially available solvent-based carpet adhesive counterpart, which exhibited a shear strength of 185.23 kPa. The tests were repeated 8 times, and the results were consistent with standard deviations of 47.08 and 54.82 kPa for Glue Composition B and the commercial carpet adhesive, respectively.

TABLE 3
Carpet shear test results comparison of glue composition
B (Wood and Leather Glue) and a commercially available
adhesive used in the flooring and carpet industry.

| | Peel Strength | Standard |
|---|---|---|
| Adhesive | (kPa) | Deviation (kPa) |
| Glue Composition B | 203.15 | 47.08 |
| Parabond M-260 Carpet Adhesive | 185.23 | 54.82 |
| (n-hexane, toluene, naphthalene) | | |

### Example 13: Allergenic Testing

### Sample Preparation

Natural rubber is known to contain Hevea Brasiliensis (Hev b) allergenic proteins. Of the 14 officially acknowledged protein allergens found in natural rubber latex, 4 are known to be the most allergenic: Hev b 1, Hev b 3, Hev b 5 and Hev b 6.02. In order to test the quantity of these allergens in the novel ammonia-free natural rubber, Alfapreno of Example 1 and Betapreno of Example 7 were compared to ammoniated natural rubber and field latex without additives. To carry out the controlled tests, 11 liters of liquid natural rubber latex tapped the same day from a plantation in the Victoria, Caldas region in Colombia, and prepared into 7 different samples, to be tested for protein content using electrophoresis testing and ELISA testing. Table 4 presents the liquid latex samples prepared for testing.

TABLE 4
Seven liquid latex samples used in the allergenic testing

| Liquid Latex Type | Specifications |
|---|---|
| Additive-free field latex (1.1 liters) | Field latex preserved at 2 degrees |
| | Celsius |
| Alfapreno (1.1 liters) | As specified in Example 1 |
| (Dry rubber content of | |
| approximately 35%) | |
| Centrifuged Alfapreno (1.1 liters) | As specified in Example 1 and |
| (Dry rubber content of | centrifuged to a dry rubber content of |
| approximately 60%) | approximately 60% |
| Betapreno (1.1 liters) | As specified in Example 7 |
| (Dry rubber content of | |
| approximately 35%) | |
| Centrifuged Betapreno (1.1 liters) | As specified in Example 7 and |
| (Dry rubber content of | centrifuged to a dry rubber content of |
| approximately 60%) | approximately 60% |
| Ammoniated latex (1.1 liters) | Combine 97.31% field latex with |
| (Dry rubber content of | 2.43% of a 24% ammonia |
| approximately 35%) | concentration, 0.14% zinc oxide and |
| | 0.12% TMTD |
| Centrifuged ammoniated latex | Combine 97.31% field latex with |
| (1.1 liters) | 2.43% of a 24% ammonia |
| (Dry rubber content of | concentration, 0.14% zinc oxide and |
| approximately 60%) | 0.12% TMTD and centrifuged to a |
| | dry rubber content of approximately |
| | 60% |

### Electrophoresis Testing

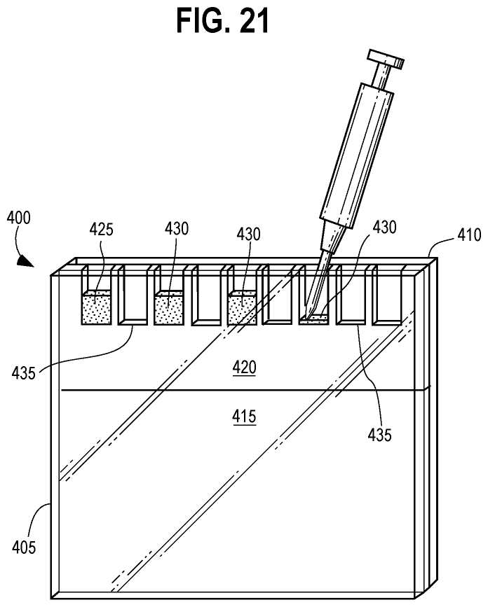

To separate and qualitatively assess content of Hev b 1, Hev b 3, Hev b 5 and Hev b 6.02 proteins of the seven liquid latex samples described in Table 4, electrophoresis testing was performed on each of the samples. Two separate tests were performed, one for the four uncentrifuged and one for the three centrifuged samples. For each test, an approximately 0.75 mm thick vertically stacked two-layer gel system, stacking gel and resolving gel, held in place between two glass plates, was used. FIG. 21 schematically illustrates a vertical gel system 400 (hereinafter, the “system 400”) designed to perform the electrophoresis testing described herein. In the system 400, a first glass plate 405 and a second glass plate 410 may be positioned to hold a resolving gel 415 and a stacking gel 420 between the plates 405, 410. A standard 425 and samples 430 may be deposited in sample wells 435, the sample wells 435 positioned on an upper portion of the system 400.

The composition of the resolving gel and stacking gel was comprised of three distinct solutions described in Table 5-Table 7 below. The composition of each respective gel are presented in Tables 8 and 9.

TABLE 5
Solution 1 composition

| Agent | Amount |
|---|---|
| Acrylamide [grams] | 29.2 |
| Bis-acrylamide [grams] | 0.8 |
| Fill up with distilled water to [mL] | 100 |

TABLE 6
Solution 2 composition

| Agent | Amount |
|---|---|
| (Hydroxymethyl) aminomethane Hydrochloride | 9.075 |
| (Tris-HCl) [grams] | |
| Sodium dodecyl sulfate at 0.2% concentration | 0.2 |
| [grams] | |
| Fill up with distilled water to [mL] | 100 |

TABLE 7
Solution 3 composition

| Agent | Amount |
|---|---|
| (Hydroxymethyl) aminomethane Hydrochloride | 3.0725 |
| (Tris-HCl) [grams] | |
| Sodium dodecyl sulfate at 0.2% concentration | 0.2 |
| [grams] | |
| Fill up with distilled water to [mL] | 100 |

TABLE 8
Resolving gel composition (15% gel)

| Agent | Amount |
|---|---|
| Solution 1 [mL] | 5.5 |
| Solution 2 [mL] | 5.5 |
| Ammonium persulfate at 10% concentration [μL] | 50 |
| N,N,N′,N′- tetramethyl ethylenediamine [μL] | 10 |

TABLE 9
Stacking gel composition (4% gel)

| Agent | Amount |
|---|---|
| Solution 1 [μL] | 830 |
| Solution 3 [μL] | 2500 |
| Distilled water [μL] | 1615 |
| Ammonium persulfate at 10% concentration [μL] | 50 |
| N,N,N′,N′- tetramethyl ethylenediamine [μL] | 10 |

An electrically conducting buffer composition that surrounds the gel system during the electrophoresis test was prepared (shown in Table 10). Furthermore, a dye buffer composition, shown in Table 11, was added to the liquid latex samples, as shown in Tables 12 and 13. Once prepared, the sample crucibles were heated to 100° C. for 5 minutes to allow for the sodium dodecyl sulfate to denature the proteins, resulting in the separation of proteins strictly based on their molecular weight.

TABLE 10
Surrounding buffer composition.

| Agent | Amount |
|---|---|
| (Hydroxymethyl) aminomethane (Tris-base) [grams] | 3.03 |
| Glycine [grams] | 14.4 |
| Sodium dodecyl sulfate [grams] | 1.0 |
| Fill up with distilled water to [mL] | 1000 |

TABLE 11
Dye buffer composition (for 10 mL)

| Agent | Amount |
|---|---|
| (Hydroxymethyl) aminomethane (Tris-base) [g] | 0.4 |
| Sodium dodecyl sulfate [g] | 0.8 |
| Glycerol [mL] | 4 |
| Distilled water [mL] | 2.7 |
| Bromophenol Blue [g] | 0.008 |
| β-mercaptoetanol [mL] | 2.1 |

TABLE 12
Sample preparation composition for field latex
samples (approximately 35% dry rubber content)

| Agent | Amount |
|---|---|
| Latex sample [μL] | 15 |
| Distilled water [μL] | 15 |
| Dye buffer composition [μL] | 10 |

TABLE 13
Sample preparation composition for centrifuged latex
samples (approximately 60% dry rubber content)

| Agent | Amount |
|---|---|
| Latex sample [μL] | 15 |
| Distilled water [μL] | 45 |
| Dye buffer composition [μL] | 20 |

In a next step, 5 μL samples were placed inside the wells, as depicted in FIG. 21. One standard sample, Spectra Multicolor Low Range Protein Ladder 26628, provided by Thermo Fisher, was placed inside the left well. The standard generates a standard ladder or scale within the gel that is used for the characterization of bands corresponding to proteins with a molecular weight of 40 kDa, 25 kDa, 15 kDa, 10 kDa, 4.6 kDa and 1.7 kDa.

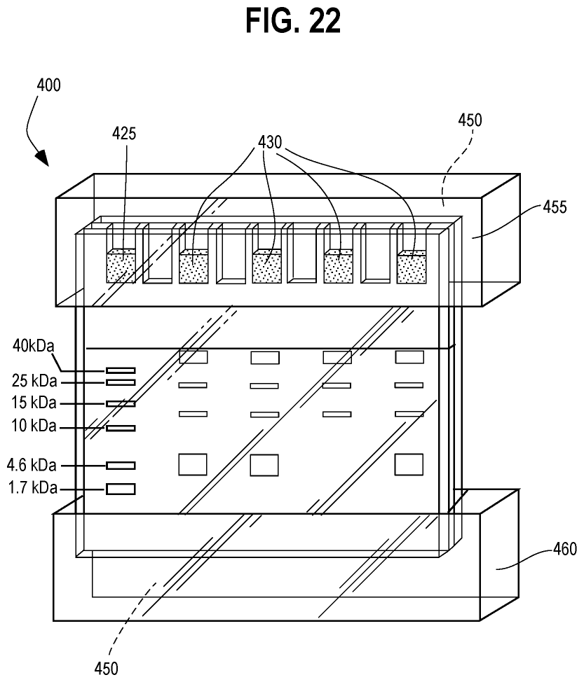

Once the liquid latex samples were deposited inside the wells, the system was placed in the surrounding buffer composition. A schematic representation of the system including the buffer composition is depicted in FIG. 22. As illustrated, buffer compositions 450 were positioned at an upper buffer area 455 and a lower buffer area 460 of the system 400. Further, a power source (not illustrated) may be coupled to the system 400 such that the upper buffer area 455 can function as a cathode and the lower buffer area 460 can function as an anode. Thus, when a voltage is applied to the system 400, proteins in the standard 425 and the samples 430 may travel through the gels 415, 420. The standard 425 is calibrated such that it provides reference points at the 1.7 kDa, 4.6 kDa, 10 kDa, 15 kDa, 25 kDa, and 40 kDa mass units, which in turn can be used to interpret the data produced by the electrophoresis testing.

A Bio-America Equipment DYY-6CBA power supply battery, set at 80V was connected to the upper (cathode) and lower (anode) surrounding buffer areas of a Bio-Rad Mini-PROTEAN Tetra System, to force the proteins to travel towards the anode (positive end) to the point where the stacking gel ends. At that point the power supply battery was set at 100V to force the proteins to travel through the resolution gel. The electrical charge was held for up to 3.5 hours to ensure that the proteins traveled the appropriate distance dictated by the ladder, until the dyed proteins are near the bottom of the resolution gel by the lower buffer area.

The next step in the denaturing polyacrylamide gel electrophoresis procedure was to remove the gel from the glass plates and fix the standard ladder in a 5% glutaraldehyde solution. Once the ladder is fixed, the gel is submerged in a recipient containing a stain with the composition seen in Table 14. The container with the submerged gel system is agitated very slowly to allow for the dye to stain the proteins, ultimately revealing the proteins throughout the gel channels. To ensure proper resolution, a de-staining solution was used to wash off the excess pigment. The de-staining solution composition is presented in Table 15 below.

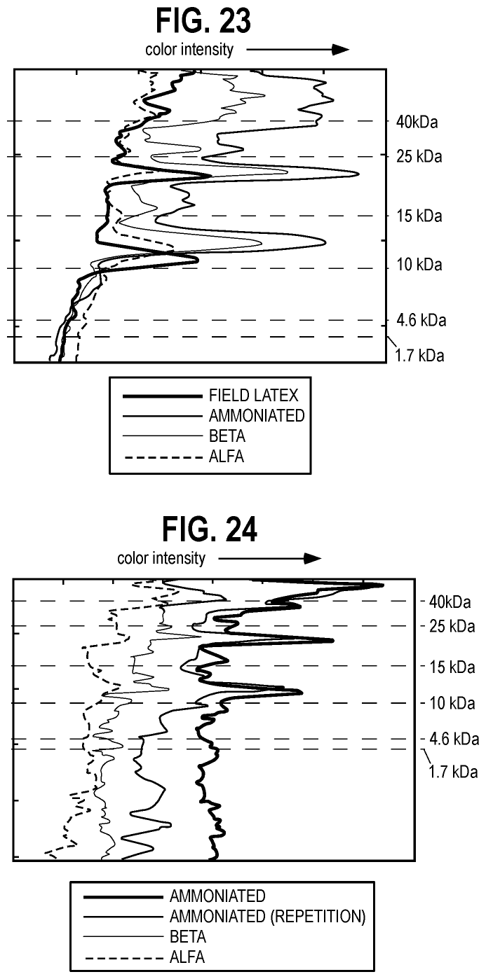

FIG. 23 presents the gel with tests performed on 35% dry rubber content samples. They are (from left to right) ammoniated latex, additive-free field latex, Alfapreno and Betapreno. Some of the samples' wells were left empty, however, they show bands due to migration from neighboring columns. The grayscale intensity of images taken of the gels were analyzed using a MATLAB program (pixel intensity of 255 reflects a perfectly white pixel and 0 a perfectly black pixel). These qualitative images and graphs clearly show the larger quantities of proteins present in the ammoniated latex. The lowest protein content can be seen in the Alfapreno sample. FIG. 24 presents the gel with tests performed on the centrifuged 60% dry rubber content samples, from left to right, Alfapreno, Betapreno, and two ammoniated latex samples. This qualitative image and graph also show a higher protein content present in the ammoniated liquid latex sample, and significantly lower protein content in the Alfapreno and Betapreno samples.

### ELISA Testing

The ELISA testing was done according to ASTM 7427: Standard Test Method for Immunological Measurement of Four Principal Allergenic Proteins (Hev b 1, 3, 5 and 6.02) in Hevea Natural Rubber and Its Products Derived from Latex. The tests were performed using a latex 4-in-1 ELISA (Hev b1, b3, b5, b6.02) assay kit, FITkit® ELISA Kit 4 Latex Allergens, manufactured by ICOSAGEN AS in Estonia.

Table 14 presents the ELISA testing results for the seven liquid latex samples presented in Table 4. The results clearly show the lower quantities of allergenic proteins in the novel ammonia-free latex. The centrifuged Alfapreno liquid latex had the lowest quantities of allergenic proteins, in agreement with the electrophoresis test results.

TABLE 14
Allergenic protein content according to ELISA test

| | | | Hev | Hev | |
|---|---|---|---|---|---|
| | Hev B1 | Hev B3 | B5 | B6.02 | Sum |
| Liquid Latex Type | (μg/L) | (μg/L) | (μg/L) | (μg/L) | (μg/L) |
| Additive-free field | >1000* | 579 | >100 | 4066 | 5745 |
| latex | | | | | |
| (approximately 35% | | | | | |
| dry rubber content) | | | | | |
| Alfapreno | <10 § | 19 | 1752 | 3551 | 5332 |
| (approximately 35% | | | | | |
| dry rubber content) | | | | | |
| Betapreno | 559 | 129 | 662 | 3445 | 4795 |
| (approximately 35% | | | | | |
| dry rubber content) | | | | | |
| Ammoniated latex | 642 | 501 | 2925 | 3076 | 7144 |
| (approximately 35% | | | | | |
| dry rubber content) | | | | | |
| Centrifuged Alfapreno | <10 § | 324 | 14 | 8271 | 8619 |
| (approximately 60% | | | | | |
| dry rubber content) | | | | | |
| Centrifuged Betapreno | >1000* | 943 | 45 | 7648 | 9636 |
| (approximately 60% | | | | | |
| dry rubber content) | | | | | |
| Centrifuged | 6239 | 530 | 5151 | 7081 | 19,001 |
| ammoniated latex | | | | | |
| (approximately 60% | | | | | |
| dry rubber content) | | | | | |

*inconclusive, outside the test range
§ below the detection limit

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of processing natural latex without the use of ammonia, the method comprising:
a stabilization step wherein a liquid latex composition is contacted with a stabilizing agent selected from the group consisting of alkylbenzene sulfonates, fatty acid alcohols, and ethoxylated fatty acid alcohols.

2. The method of claim 1 wherein the stabilizing agent comprises a surfactant selected from the group consisting of methanesulfonic acid, paratoluene sulfonic acid, 2-sulfoacetic acid, 2-naphthalensulfonic acid, 2-anthracensulfonic acid, p-methylbenzenesulfonic acid, 4-amino-2,3-dichlorobenzenesulfonic acid, benzenesulfonic acid, 1-phenanthanesulfonic acid, phenolsulfonic acid, ethanesulfonic acid, propanesulfonic acid, butanesulfonic acid, pentanesulfonic acid, hexanesulfonic acid, heptanesulfonic acid, octanesulfonic acid, nonanesulfonic acid, decanosulfonic acid, isopropanesulfonic acid, terbutanesulfonic acid, benzenesulfonic acid, ortho-toluenesulfonic acid, dodecylbenzene sulfonic acid, methylbenzene sulfonic acid, tertbutyl sulfonic acid, propylbenzene sulfonic acid, methylbenzene sulfonic acid, ethylbenzene sulfonic acid, butylbenzene sulfonic acid, pentylbenzene sulfonic acid, hexylbenzene sulfonic acid, heptylbenzene sulfonic acid, octylbenzene sulfonic acid, nonylbenzene sulfonic acid, decabenzene sulfonic acid, undecabenzene sulfonic acid, trifluoromethanesulfonic acid, 10-camphorsulfonic acid, metasulfonic acid, xylenesulfonic acid, lauric alcohol, ethoxylated lauric alcohol, ethoxylated long chain alcohols having from 7 to 15 carbons, and mixtures or combinations thereof.

3. The method of claim 2 wherein the stabilizing agent comprises an ethoxylated lauric alcohol.

4. The method of claim 2 wherein the stabilizing agent comprises a dodecylbenzene sulfonic acid.

5. The method of any one of claims 1 to 4 wherein the stabilization step comprises adding the stabilizing agent in an amount of from about 0.1% to about 30% by volume, or from about 0.5% by volume to about 5% by volume, relative to the initial volume of the liquid latex composition.

6. The method of any one of claims 1 to 5 wherein the stabilization step comprises adding the stabilizing agent in an amount of at least about 0.1% by volume, at least about 0.2% by volume, at least about 0.5% by volume, at least about 1.0% by volume, at least about 1.5% by volume, or at least about 2.0% by volume relative to the initial volume of the liquid latex composition.

7. The method of any one of claims 1 to 6 wherein the stabilization step comprises adding the stabilizing agent in an amount of from about 0.5% to about 3% by volume, for example about 0.5% to about 2.5%, or from about 1% to about 2% by volume relative to the initial volume of the liquid latex composition.

8. A method of processing natural latex without the use of ammonia, the method comprising:
a stabilization step wherein a liquid latex composition is refrigerated at a temperature of no greater than about 5° C. for a period of at least about 12 hours.

9. The method of claim 8 wherein the liquid latex composition is refrigerated at a temperature of no greater than about 4° C. or no greater than about 3° C.

10. The method of claim 8 or 9 wherein the liquid latex composition is refrigerated for a period of at least about 16 hours, at least about 20 hours, at least about 24 hours, at least about 30 hours, at least about 36 hours, or at least about 48 hours.

11. The method of any one of claims 1 to 10 further comprising a preservation step wherein the liquid latex composition is contacted with a preserving agent, and wherein the preserving agent does not comprise ammonia.

12. The method of claim 11 wherein the preserving agent comprises an acid.

13. The method of claim 12 wherein the preserving agent comprises a halogenated acid.

14. The method of claim 13 wherein the preserving agent comprises a halogenated acid selected from the group consisting of hydrochloric acid, hydrofluoric acid, iodic acid, and hydrobromic acid.

15. The method of claim 14 wherein the preserving agent comprises hydrofluoric acid.

16. The method of any one of claims 11 to 15 wherein the stabilization step is carried out prior to the preservation step.

17. The method of any one of claims 11 to 15 wherein the stabilization step and the preservation step are carried out simultaneously.

18. The method of any one of claims 11 to 17 wherein the preservation step comprises adding the stabilizing agent in an amount of from about 0.05% to about 30% by volume, or in an amount of from about 0.1% by volume to about 5% by volume, relative to the initial volume of the liquid latex composition.

19. The method of any one of claims 11 to 18 wherein the preservation step comprises adding the preserving agent in an amount of at least about 0.05% by volume, at least about 0.1% by volume, at least about 0.2% by volume, at least about 0.5% by volume, at least about 1.0% by volume, at least about 1.5% by volume, or at least about 2.0% by volume relative to the initial volume of the liquid latex composition.

20. The method of any one of claims 11 to 19 wherein the preservation step comprises adding the preserving agent in an amount of from about 0.05% to about 2% by volume, from about 0.05% to about 1%, or from about 0.1% to about 0.5% by volume relative to the initial volume of the liquid latex composition.

21. The method of any one of claims 1 to 20 further comprising a pH adjustment step wherein the liquid latex composition is contacted with a pH adjusting agent

22. The method of claim 21 wherein the pH of the liquid latex composition prior to the pH adjustment step is less than about 6.

23. The method of claim 21 or 22 wherein the pH of the liquid latex composition following the pH adjustment step is from about 6 to about 10.

24. The method of any one of claims 21 to 23 wherein the pH adjustment agent is selected from the group consisting of sodium hydroxide, potassium hydroxide, amines, and mixtures or combinations thereof.

25. The method of any one of claims 1 to 24 further comprising a coagulation step wherein the liquid latex composition is contacted with a coagulating agent, thereby forming a solid latex composition.

26. The method of claim 25 wherein the coagulating agent comprises an alcohol.

27. The method of claim 26 wherein the coagulating agent comprises a C₁ to C₈ alcohol.

28. The method of claim 27 wherein the coagulating agent comprises a C₁ to C₈ alcohol.

29. The method of claim 28 wherein the coagulating agent comprises an alcohol selected from the group consisting of methanol, ethanol, n-propanol, benzyl alcohol, isopropyl alcohol, isobutyl alcohol, tertiary butyl alcohol, pentanol, hexanol, heptanol, octanol, and mixtures or combinations thereof.

30. The method of claim 29 wherein the coagulating agent comprises ethanol.

31. The method of any one of claims 25 to 30 wherein the coagulation step comprises adding the coagulating agent in an amount of from about 0.5% to about 50% by volume, relative to the initial volume of the liquid latex composition.

32. The method of any one of claims 25 to 30 wherein the coagulation step comprises adding the coagulating agent in an amount of from about 10% to about 50% by volume, from about 15% to about 40%, or from about 20% to about 40% by volume relative to the initial volume of the liquid latex composition

33. The method of any one of claims 25 to 32 wherein the coagulation step comprises adding the coagulating agent in an amount of at least about 1% by volume, at least about 5% by volume, at least about 10% by volume, at least about 15% by volume, at least about 20% by volume, at least about 25% by volume, or at least about 30% by volume relative to the initial volume of the liquid latex composition.

34. The method of any one of claims 25 to 33 further comprising a storage step wherein the liquid latex composition is stored for a period of at least about 1 day subsequent to the stabilization step and prior to the coagulation step.

35. The method of claim 34 wherein the liquid latex composition is stored for a period of at least about 1 week, at least about 2 weeks, at least about 3 weeks, at least about 4 weeks, at least about 1 month, at least about 2 months, at least about 3 months, at least about 6 months, at least about 1 year, at least about 2 years, or at least about 3 years.

36. A stabilized and preserved liquid latex composition prepared according to the method of any one of claims 1 to 24.

37. A stabilized and preserved liquid latex composition comprising:
(a) latex; and
(b) a stabilizing agent comprising a surfactant selected from the group consisting of alkylbenzene sulfonates, fatty acid alcohols, and ethoxylated fatty acid alcohols.

38. The composition of claim 37 comprising latex in an amount of from about 80% by volume to about 99% by volume.

39. The composition of claim 38 comprising latex in an amount of at least about 80% by volume, at least about 85% by volume, at least about 90% by volume, at least about 95% by volume, at least about 96% by volume, at least about 97% by volume, at least about 98% by volume, or at least about 99% by volume.

40. The composition of claim 39 comprising the stabilizing agent in an amount of from about from about 0.1% to about 30% by volume, or from about 0.5% by volume to about 5% by volume.

41. The composition of claim 40 comprising the stabilizing agent in an amount of at least about 0.1% by volume, at least about 0.2% by volume, at least about 0.5% by volume, at least about 1.0% by volume, at least about 1.5% by volume, or at least about 2.0% by volume.

42. The composition of any one of claims 37 to 41 wherein the stabilizing agent comprises a surfactant selected from the group consisting of methanesulfonic acid, paratoluene sulfonic acid, 2-sulfoacetic acid, 2-naphthalensulfonic acid, 2-anthracensulfonic acid, p-methylbenzenesulfonic acid, 4-amino-2,3-dichlorobenzenesulfonic acid, benzenesulfonic acid, 1-phenanthanesulfonic acid, phenolsulfonic acid, ethanesulfonic acid, propanesulfonic acid, butanesulfonic acid, pentanesulfonic acid, hexanesulfonic acid, heptanesulfonic acid, octanesulfonic acid, nonanesulfonic acid, decanosulfonic acid, isopropanesulfonic acid, terbutanesulfonic acid, benzenesulfonic acid, ortho-toluenesulfonic acid, dodecylbenzene sulfonic acid, methylbenzene sulfonic acid, tertbutyl sulfonic acid, propylbenzene sulfonic acid, methylbenzene sulfonic acid, ethylbenzene sulfonic acid, butylbenzene sulfonic acid, pentylbenzene sulfonic acid, hexylbenzene sulfonic acid, heptylbenzene sulfonic acid, octylbenzene sulfonic acid, nonylbenzene sulfonic acid, decabenzene sulfonic acid, undecabenzene sulfonic acid, trifluoromethanesulfonic acid, 10-camphorsulfonic acid, metasulfonic acid, xylenesulfonic acid, lauric alcohol, ethoxylated lauric alcohol, ethoxylated long chain alcohols having from 7 to 15 carbons, and mixtures or combinations thereof.

43. The composition of claim 42 wherein the stabilizing agent comprises an ethoxylated lauric alcohol.

44. The composition of claim 43 wherein the stabilizing agent comprises a dodecylbenzene sulfonic acid.

45. The composition of any one of claims 37 to 44 further comprising:
(c) a preserving agent comprising an acid.

46. The composition of claim 45 wherein the preserving agent comprises a halogenated acid.

47. The composition of claim 46 wherein the preserving agent comprises a halogenated acid selected from the group consisting of hydrochloric acid, hydrofluoric acid, iodic acid, and hydrobromic acid.

48. The composition of claim 47 wherein the preserving agent comprises hydrofluoric acid.

49. The composition of any one of claims 45 to 48 comprising the preserving agent in an amount of from about from about 0.1% to about 30% by volume, or from about 0.5% by volume to about 5% by volume.

50. The composition of any one of claims 45 to 49 comprising the preserving agent in an amount of at least about 0.05% by volume, at least about 0.1% by volume, at least about 0.2% by volume, at least about 0.5% by volume, at least about 1.0% by volume, at least about 1.5% by volume, or at least about 2.0% by volume.

51. A method of preparing an ammonia-free solid rubber composition, the method comprising contacting a preserved and stabilized liquid latex composition of any one of claims 36 to 50 with a coagulating agent.

52. The method of claim 51 wherein the coagulating agent comprises an alcohol.

53. An ammonia-free solid rubber composition prepared according to the method of claim 51 or 52.
